(19) United States
(12) Patent Application Publication
(10) Pub. No.: US 2008/0170406 A1
(43) Pub. Date: Jul. 17, 2008

(54) Structure of car door guard

(76) Inventor: Yi-Tzu Lan, (US)

Correspondence Address: BIRCH STEWART KOLASCH & BIRCH, PO BOX 747, FALLS CHURCH, VA, 22040-0747, US

(21) Appl. No.: 11/653,280

(22) Filed: Jan. 16, 2007

(51) Int. Cl. F21W 101/02

(52) U.S. Cl. 362/501; 362/487

(57) ABSTRACT

A structure of car door guard mainly comprises a one-piece pad for maximum cushioning; the characteristic lies in: an illuminant strip is snugly fitted in a furrow cut along the length of the pad. The illuminant strip would allow the structure glowing while being connected to power source. The structure can be mounted on doors of any cars for maximum cushioning and/or embellishment as it would glow to make the car doors glistening at night so as to provide alert and irradiate the car.

### BACKGROUND OF THE INVENTION

I. Field of the Invention

The present invention relates to a structure of car door guard, particularly to a structure that comprises a one-piece rubber or plastic pad to be mounted on doors of any cars for maximum cushioning. Also, an illuminant strip is mounted inside the said rubber or plastic pad to allow the structure of the present invention emitting light that makes the car doors glistening at night so as to provide alert. The illuminant strip, which is snugly fitted into a furrow cut along the length of said pad, would glow or blink light while being connected to power source.

II. Description of the Prior Art

Nowadays, the cars are popular transport in our daily life and play increasingly important role in our leisure life. Moreover, a car and the decoration on it somehow reveal owner's taste and characteristic. To distinguish individual taste and characteristic, an increasing number of enthusiasts are zealous in glamorizing their cars; nonetheless, they attempt to enhance driving safety at the same time. Therefore, an assembly that enhances driving safety and embellishes the car at the same time by comprising an illuminant element to make the car doors glistening so as to provide alert and irradiate the car at night should be the perfect product that fulfills those enthusiasts' dream.

By contrast, though being one-piece rubber or plastic pads dedicated to cushioning, the car door guards of the prior art are devoid of illuminant that glows to make the car doors glistening at night so as to provide alert and irradiate the car, hardly satisfying those enthusiasts

### SUMMARY OF THE INVENTION

To improve the drawbacks of the car door guards of the prior art, the present invention aims at providing an innovative “structure of car door guard”.

Main objective of the present invention is to provide a structure of car door guard that irradiates the car at night so as to enhance driving safety. The structure would be constructed with a cushion pad and an illuminant strip, which is snugly fitted into a furrow cut along the length of the pad. The structure would glow to make the car doors glistening so as to give alert at night when the illuminant strip is connected to power source.

To achieve the foregoing objective, the structure of the present invention mainly comprises a one-piece pad; the characteristic lies in: an illuminant strip is snugly fitted into a furrow cut along the length of the pad.

According to the foregoing description, the structure of the present invention can be mounted on doors of any cars for maximum cushioning and/or embellishment. In addition, the structure of the present invention can glow or blink mono- or multicolor lights that make the car doors glistening at night so as to provide alert when the foregoing illuminant strip is connected to power source.

### BRIEF DESCRIPTION OF THE DRAWINGS

FIG. 1 is a three-dimensional view showing an embodiment of the invention.

FIG. 2 is a cross-sectional view showing assembly of the embodiment in FIG. 1.

FIGS. 3A, 3B and 3C are sectional views showing embodiments of the illuminants of the invention.

FIG. 4 is a diagram showing the invention mounted on a car.

### DESCRIPTION OF THE PREFERRED EMBODIMENTS

Desirable structure, assembly and features of the present invention will be better understood from the detailed description and drawings that follow, in which various embodiments of the disclosed invention are illustrated by way of example.

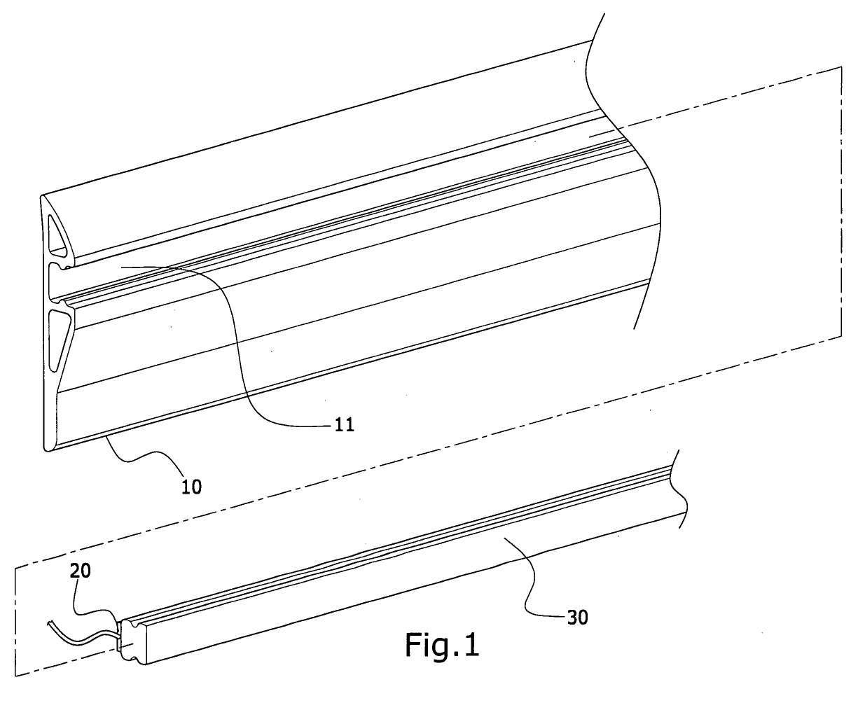

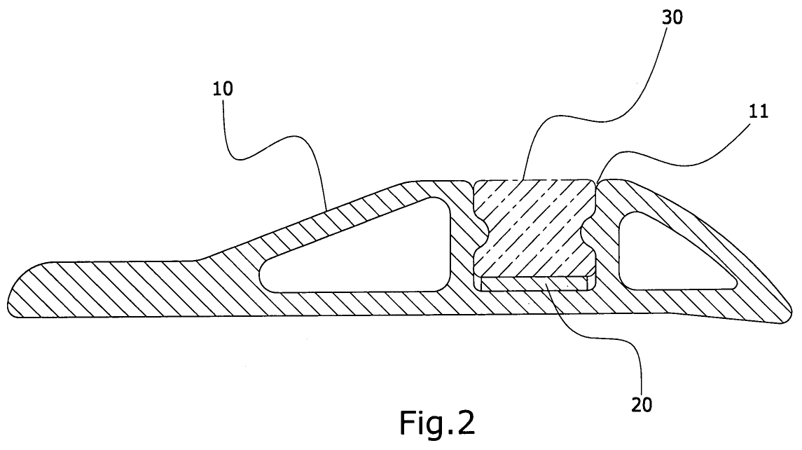

With reference to FIGS. 1 and 2, the structure of door guard of the present invention mainly comprises a one-piece pad 10 for maximum cushioning; the characteristic lies in: an illuminant strip 20 is snugly fitted into a furrow 11 that is cut along the length of the pad 10.

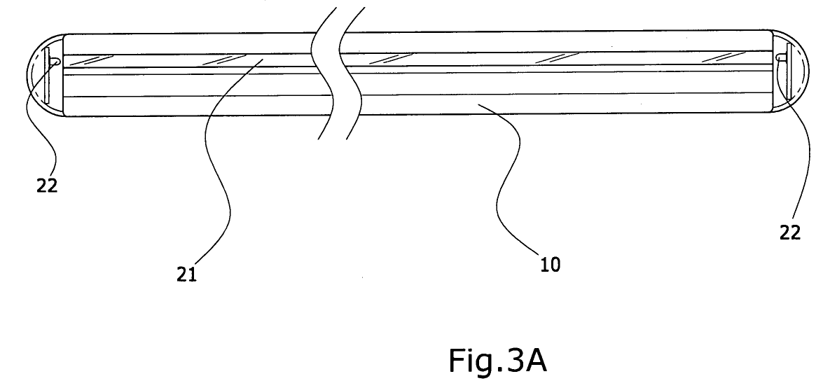

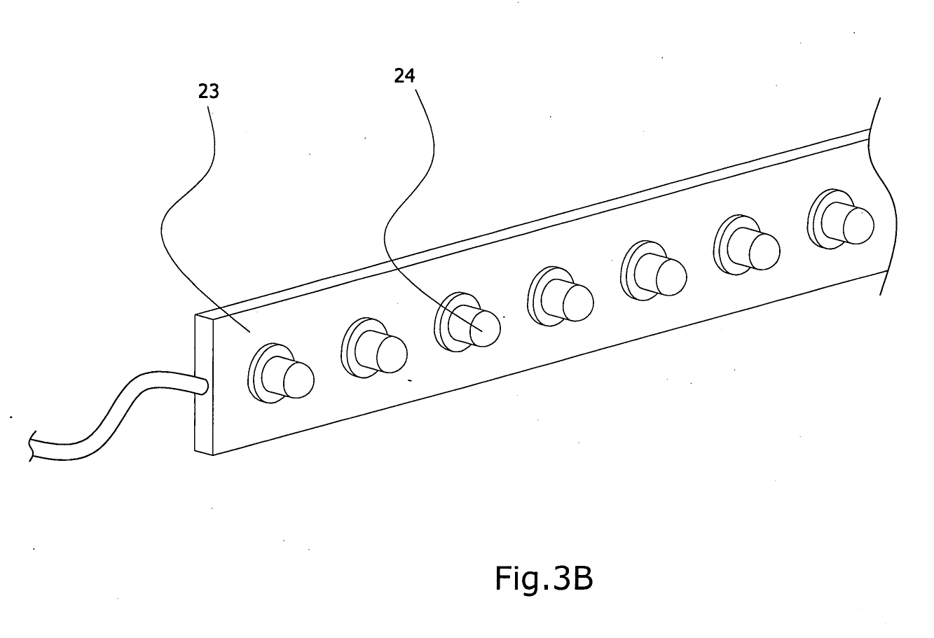

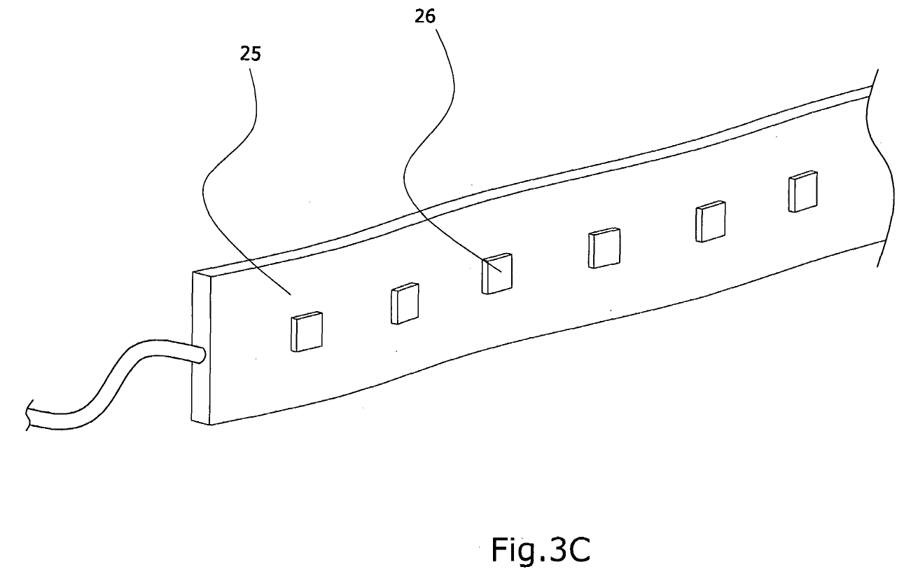

According to the foregoing structures the illuminant strip 20 may be an EL lamp, also known as luminescent light (as shown in FIG. 1), which is made of polyester film and emits the light by field effect. In the embodiment, the EL lamp can be stuck to the back surface of a transparent plastic bar 30 or coated on the inside of the furrow 11. Besides, said illuminant strip 20 may be constructed by one or two LED lamps 22 mounted on one end or both ends of a light guide bar 211 (as shown in FIG. 3A); a plurality of LED lamps 24 mounted on a long circuit board 23 (as shown in FIG. 3B); or a plurality of illuminant chips 26 mounted on a long soft circuit board 23 (as shown in FIG. 3C). In addition, a transparent plastic bar 30 or a transparent protective film may be put to cover said illuminant strip 20 so as to enhance the practicability of the present invention.

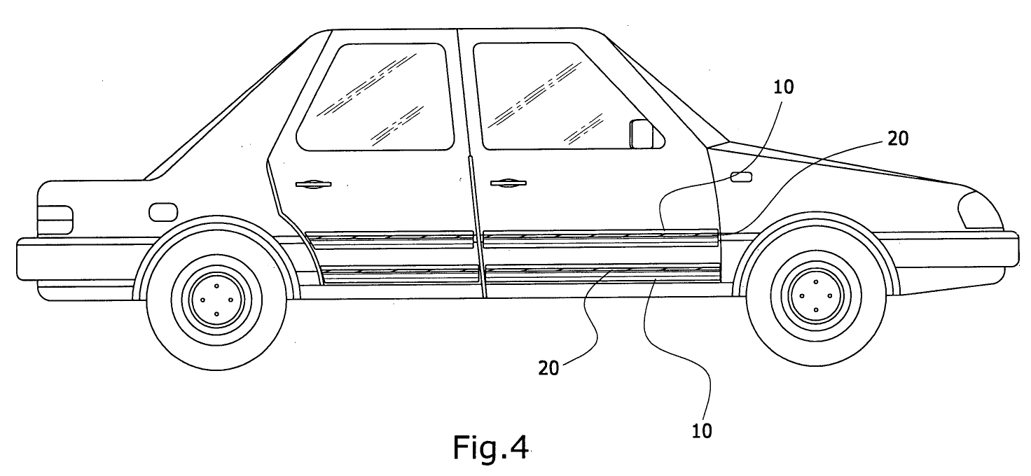

As shown in FIG. 4, the structure of car door guard of the present invention can be mounted on loin and/or bottom edge of car doors for maximum cushioning and/or embellishment. The structure of door guard of the present invention can emit light to make the car doors glistening at night so as to give alert and irradiate the car as it comprises a long illuminant 20, which glows or blinks with mono- or multicolor lights while being connected to power source.

While the present invention is susceptible to various modifications and alternative forms, specific embodiments have been shown by way of example in the drawings and described in detail herein. However, it should be understood that the invention is not intended to be limited to the particular form disclosed. Rather, the invention is to cover all modifications, equivalents, and alternatives falling within the spirit and scope of the invention as defined by the appended claims.

To sum up, the “structure of car door guard” of the present invention possesses the “practicability” and the “advancement” of the industry as it provides both maximum cushioning and embellishment by making the car doors glistening at night so as to provide alert and irradiate the car.

What is claimed is:

1. A structure of car door guard comprises a one-piece pad for maximum cushioning; the characteristic lies in:
an illuminant strip is snugly fitted into a furrow that is cut along the length of the pad.

2. The structure of car door guard of claim 1, wherein the illuminant strip is an EL lamp, which is made of polyester film and emits light by field effect.

3. The structure of car door guard of claim 1, wherein the illuminant strip is constructed by one or two LED lamps mounted on one end or both ends of a light guide bar.

4. The structure of car door guard of claim 1, wherein the illuminant strip is constructed by a plurality of LED lamps mounted on a long circuit board.

5. The structure of car door guard of claim 1, wherein the illuminant strip is constructed by a plurality of illuminant chips 26 mounted on a long soft circuit board.
